(19) United States
(12) Patent Application Publication
(10) Pub. No.: US 2009/0020092 A1
(43) Pub. Date: Jan. 22, 2009

(54) ENGINE STARTING DEVICE

(75) Inventors: Kazuyoshi Kishibata, Shizuoka-Ken (JP); Tsuneaki Endou, Shizuoka-Ken (JP)

Correspondence Address: PEARNE & GORDON LLP, 1801 EAST 9TH STREET, SUITE 1200, CLEVELAND, OH, 44114-3108, US

(73) Assignee: Kokusan Denki Co., Ltd., Shizuoka-Ken (JP)

(21) Appl. No.: 12/174,842

(22) Filed: Jul. 17, 2008

(30) Foreign Application Priority Data
Jul. 18, 2007 (JP) 2007-186767

(51) Int. Cl. F02N 3/00; F02N 17/00

(52) U.S. Cl. 123/179.3; 123/179.5

(57) ABSTRACT

An engine starting device including: a battery capacity monitoring portion that estimates a remaining capacity of a battery; a start time starter driving portion that supplies a driving current from the battery to a starter generator for causing cranking of the engine when a start mode of the engine is a normal start mode; and a display portion that displays that the cranking for starting the engine is to be performed by a manual starter when the estimated remaining capacity of the battery is insufficient, wherein the driving of the starter generator is prohibited and the start mode of the engine is switched to the manual start mode when the estimated remaining capacity of the battery is insufficient.

### TECHNICAL FIELD OF THE INVENTION

The present invention relates to an engine starting device for starting an engine supplied with fuel by a fuel injection device and ignited by an ignition device.

### PRIOR ART OF THE INVENTION

If a situation occurs where an outboard engine cannot be started on the ocean, crews may be lost. Thus, even when the outboard engine includes an electric starter, the outboard engine also often includes a manual starter for manual cranking such as a recoil starter or a rope starter. Similarly, in a vehicle such as a snow mobile used in a snow-covered mountain, which needs to avoid a situation where an engine cannot be started as much as possible, both an electric starter and a manual starter are often provided as devices for starting the engine. Also, in a small motorcycle, both an electric starter and a manual starter such as a kick starter are sometimes provided.

For an engine including an electric starter and a manual starter, a manual starter such as a recoil starter or a kick starter is used to start the engine in the case where a remaining capacity of a battery is insufficient, and start operation is performed by the electric starter to reduce a voltage of the battery and prevent a fuel injection device and an ignition device from being operated, and the case where the remaining capacity of the battery is insufficient and thus the electric starter cannot perform cranking at a rotational speed required for starting the engine.

Even if a remaining capacity of a battery is insufficient, a manual starter is used to perform cranking without driving a starter motor that consumes a large amount of electric power, and thus a fuel injection device and an ignition device can be often operated to start an engine. A starting device of an engine including an electric starter and a manual starter is disclosed in, for example, Japanese Patent Application Laid-open No. 6-167263.

A conventional electric starter includes a starter motor used only for performing cranking of an engine, which inevitably increases the size of the engine. Thus, it has been proposed that a rotor of a rotating electric machine including a magneto rotor is mounted to a crankshaft of an engine, the rotating electric machine is operated as a starter motor to start the engine, and after the start of the engine, the rotating electric machine is operated as a magneto generator, and electric power for driving electrical components is obtained from the magneto generator. A rotating electric machine used in such a manner is referred to as a starter generator. An engine started by a starter generator also sometimes needs a manual starter depending on use.

Even if an engine includes both an electric starter and a manual starter, a driver operates the electric starter many times with an insufficient remaining capacity of a battery to cause the battery to be excessively exhausted, which prevents a fuel injection device and an ignition device from being operated, and thus prevents even the manual starter from starting the engine.

A relatively small engine can be started by a manual starter provided together with an electric starter, but it is difficult that an engine having a displacement of 800 cc or more is started by a manual starter.

### SUMMARY OF THE INVENTION

An object of the present invention is to provide an engine starting device that prevents an engine from being repeatedly started by an electric starter with an insufficient remaining capacity of a battery and avoids a situation where the engine cannot be started by a manual starter in an engine including both the electric starter and the manual starter.

Another object of the present invention is to provide an engine starting device that prevents an engine from being repeatedly started by an electric starter and avoids a situation where the engine cannot be started by a manual starter, and facilitates the start of the engine by the manual starter.

The present invention is applied to an engine starting device for starting an engine supplied with fuel by a fuel injection device and ignited by an ignition device.

The engine starting device according to the present invention includes: a starter motor that drives a crankshaft of an engine at the start of the engine; a manual starter that is manually driven to perform cranking for starting the engine; a battery capacity monitoring portion that estimates a remaining capacity of a battery that supplies a driving current to the starter motor; a start mode switching portion that switches a start mode of the engine between a normal start mode and a manual start mode; a start time starter driving portion that supplies the driving current from the battery to the starter motor for causing the cranking of the engine when the start mode is the normal start mode; and a display portion that displays that the cranking for starting the engine is to be performed by the manual starter when the start mode is switched to the manual start mode.

The start mode switching portion is comprised so as to set the start mode to the normal start mode and cause the start time starter driving portion to start supplying the driving current to the starter motor when a start command of the engine is given, then keep the start mode of the engine in the normal start mode when the remaining capacity of the battery estimated by the battery capacity monitoring portion is checked and the remaining capacity of the battery is equal to or larger than a capacity required for the starter motor to start the engine, and prohibit the driving of the starter motor by the starter driving portion and switch the start mode of the engine to the manual start mode when the remaining capacity of the battery estimated by the battery capacity monitoring portion is smaller than the capacity required for starting the engine.

In the engine starting device, when the driving of the starter motor is started, the battery capacity monitoring portion first estimates the remaining capacity of the battery. When the battery capacity monitoring portion estimates that the remaining capacity of the battery is sufficient, the driving of the starter motor is continued to start the engine. When the battery capacity monitoring portion estimates that the remaining capacity of the battery is insufficient, the start mode switching portion immediately prohibits the driving of the starter motor and switches the start mode to the manual start mode, thereby preventing the battery from being excessively exhausted.

Even when the remaining capacity of the battery is insufficient for the starter motor to start the engine, generally, a manual start can be performed (without driving the starter motor) to drive the ignition device and the fuel injection device. Thus, the driving of the starter motor is stopped to perform the manual start so as to prevent the battery from being exhausted, thereby allowing the engine to be started. Thus, comprised as described above, a situation where the engine cannot be completely started can be avoided, taking the advantage of providing the manual starter together with the electric starter.

In a preferred aspect of the present invention, a starter assisting portion is provided that monitors a voltage of the battery and drives the starter motor as far as the voltage of the battery is equal to or higher than a voltage value required for operating the ignition device and the fuel injection device to assist the cranking by the manual starter when the manual starter performs the cranking of the engine.

Comprised as described above, when, for example, a rope of a recoil starter is pulled to start the engine in the manual start mode, the starter motor can be driven to provide a drive force required for the cranking also from the starter motor to the crankshaft of the engine, thereby facilitating the start of the engine, and allowing an engine having a large displacement (for example, an engine having a displacement of 800 cc or more) to be started in the manual start mode. When the starting operation by the manual starter is assisted, the battery voltage is monitored, and the starter motor is driven as far as the battery voltage is equal to or higher than the voltage value required for operating the ignition device and the fuel injection device, thereby preventing the battery from being excessively exhausted.

In a preferred aspect of the present invention, there are provided a manual start mode time fuel injection control portion that starts driving a fuel pump of the fuel injection device immediately after the commencement of the starting operation in the manual start mode, and causes first fuel injection after the commencement of the starting operation when a driving time of the fuel pump reaches a set time; and a start time ignition control portion that controls the ignition device so as to ignite the engine at a crank angle position at which a piston of the engine reaches the top dead center of a compression stroke, or a crank angle position delayed from the crank angle position at which the piston reaches the top dead center of the compression stroke, until the start of the engine is completed.

Comprised as described above, when the starting operation in the manual start mode is commenced, the fuel injection can be performed without delay, thereby improving startability of the engine.

If ignition is performed before the piston in a cylinder in which initial explosion is performed at the start of the engine reaches the top dead center of the compression stroke when a cranking speed at the start is low, the piston cannot exceed the top dead center of the compression stroke and is pushed back, which may cause failure in the start of the engine.

On the other hand, as described above, the engine is ignited at the crank angle position at which the piston of the engine reaches the top dead center of the compression stroke, or the crank angle position delayed from the crank angle position at which the piston reaches the top dead center of the compression stroke at the start of the engine. This can prevent the situation in which the piston cannot exceed the top dead center of the compression stroke and is pushed back when the cranking speed is low, thereby ensuring the start of the engine.

In a preferred aspect of the present invention, the engine starting device includes: a starter generator that includes a rotor having a magnetic field and directly connected to a crankshaft of the engine, a stator having a polyphase armature coil, and a Hall sensor that detects a polarity of a magnetic pole of the rotor on the side of the stator to detect a rotational angle position of the rotor, operates as a starter motor when a driving current is supplied to the armature coil according to a detected output of the Hall sensor, and operates as a generator when the rotor is driven by the engine; a manual starter that is manually driven to perform cranking for starting the engine; a battery capacity monitoring portion that estimates a remaining capacity of a battery that supplies the driving current to the starter generator; a start mode switching portion that switches a start mode of the engine between a normal start mode and a manual start mode; a start time starter driving portion that operates the starter generator as the starter motor and supplies the driving current from the battery to the starter generator according to the output of the Hall sensor for causing the cranking of the engine mode is the normal start mode; and a display portion that displays that the cranking for starting the engine is to be performed by the manual starter when the start mode is switched to the manual start mode.

In this case, the start mode switching portion is comprised so as to set the start mode to the normal start mode and cause the start time starter driving portion to start supplying the driving current to the starter generator when a start command of the engine is given, then keep the start mode of the engine in the normal start mode when the remaining capacity of the battery estimated by the battery capacity monitoring portion is checked and the remaining capacity of the battery is equal to or larger than a capacity required for the starter generator to start the engine, and prohibit the driving of the starter motor by the starter driving portion and switch the start mode of the engine to the manual start mode when the remaining capacity of the battery estimated by the battery capacity monitoring portion is smaller than the capacity required for starting the engine.

Also in the case of the start mode switching portion comprised as described above, when the remaining capacity of the battery is sufficient, the driving of the starter generator as the starter motor is continued to start the engine. When it is determined that the remaining capacity of the battery is insufficient, the start mode switching portion immediately prohibits the driving of the starter generator as the starter motor and switches the start mode to the manual start mode, thereby preventing the battery from being excessively exhausted. Thus, a situation where the engine cannot be completely started can be avoided, taking the advantage of providing the manual starter together with the electric starter.

As described above, also in the case of using the starter generator including the rotor directly connected to the crankshaft of the engine, a starter assisting portion is preferably provided that monitors a voltage of the battery and drives the starter generator as the motor as far as the voltage of the battery is equal to or higher than a voltage value required for operating the ignition device and the fuel injection device to assist the cranking by the manual starter when the manual starter performs the cranking of the engine, for facilitating the start of the engine by the manual starter.

As described above, also in the case of using the starter generator, there are preferably provided a manual start mode time fuel injection control portion that starts driving a fuel pump of the fuel injection device immediately after the commencement of the starting operation in the manual start mode, and causes first fuel injection after the commencement of the starting operation when a driving time of the fuel pump reaches a set time; and a start time ignition control portion that controls the ignition device so as to ignite the engine at a crank angle position at which a piston of the engine reaches the top dead center of a compression stroke, or a crank angle position delayed from the crank angle position at which the piston reaches the top dead center of the compression stroke, until the start of the engine is completed.

As described above, in the case where the starter generator is mounted to the engine, the start time ignition control portion is preferably comprised so as to obtain rotational position information and crank angle position information of the engine required for controlling the ignition device from the output of the Hall sensor provided in the starter generator.

Generally, as a signal source that generates signals for obtaining rotational position information and crank angle position information of an engine, a pulse signal generator is used comprised of a reluctor (inductor) provided on a rotor that rotates with a crankshaft, and a signal armature (pickup coil) that detects a leading edge and a trailing edge in a rotational direction of the reluctor to generate pulses having different polarities. Since the pulse signal generator detects changes in magnetic flux with time and induces pulses, it is difficult for the pulse signal generator to generate pulse signals equal to or higher than a threshold level when a rotational speed of the engine is extremely low.

On the other hand, the Hall sensor can detect angle information even when the rotational speed of the engine is extremely low (even when the rotational speed is zero). Thus, the rotational speed and the crank angle position of the engine required for controlling the ignition device are detected from the output of the Hall sensor when the engine is started in the manual start mode, thereby allowing the ignition position to be properly controlled even at an extremely low cranking speed, and improving startability of the engine.

In a preferred aspect of the present invention, the start time starter driving portion is comprised so as to once rotate the crankshaft in a direction reverse to a start direction to cause the cranking of the engine when the start command is given, and then rotate the crankshaft in the start direction to cause the cranking of the engine.

As described above, the crankshaft is once reversely rotated when the start command is given, and thus an opportunity to inject fuel can be provided in preparation for ignition first performed after the commencement of the starting operation, before the start of a compression stroke first performed in the engine after the commencement of the starting operation. Thus, combustion can be performed by ignition first performed after the start of a forward rotation of the crankshaft, and initial explosion of the engine is performed at an early stage to improve startability.

In a preferred aspect of the present invention, a normal start time fuel injection control portion is provided that causes first fuel injection after the commencement of the starting operation when the cranking performed by reversely rotating the crankshaft is finished.

In a preferred aspect of the present invention, the start time starter driving portion is comprised so as to continuously drive the starter generator as the starter motor in the direction of starting the engine until the start of the engine is confirmed as far as the voltage of the battery is equal to or higher than a voltage value required for operating the ignition device and the fuel injection device, when the crankshaft stops before the piston in the cylinder of the engine reaches the top dead center of the compression stroke.

The start time starter driving portion is comprised as described above, and thus when maximum load torque applied to the crankshaft of the engine is more excessive than output torque of the starter motor, and the crankshaft stops or nearly stops before the piston in the cylinder reaches the top dead center of the compression stroke, a gradual reduction in compression torque by compression leak of the engine can be used to complete the compression stroke of the engine, thereby improving startability of the engine.

The battery capacity monitoring portion may be comprised of an output current detection portion that detects an output current of the battery, a battery voltage detection portion that detects a voltage of the battery, a remaining capacity estimating determined value arithmetical operation portion that arithmetically operates a determined value to be compared with a detected value of the battery voltage detected by the battery voltage detection portion for estimating the remaining capacity of the battery, with respect to the output current of the battery detected by the output current detection portion, and a battery capacity estimation portion that compares the detected value of the battery voltage detected by the battery voltage detection portion with the determined value, and estimates that the remaining capacity of the battery is equal to or larger than a capacity required for starting the engine when the detected battery voltage is the determined value or more.

In a preferred aspect of the present invention, a cylinder head of the engine includes a decompression hole that provides communication between each cylinder and the outside, and a decompression valve that can be controlled to open and close the decompression hole, and a valve control portion is further provided that controls the decompression valve so as to be opened when the start mode is switched to the manual start mode, and closed after initial explosion of the engine is completed.

The decompression hole is provided as described above, and thus an air/fuel mixture in the cylinder is released through the decompression hole in the process of the piston being displaced toward the top dead center of the compression stroke, thereby reducing torque required for the cranking of the engine, and facilitating the start of the engine by the manual starter.

The decompression hole is preferably provided so as to provide communication between each cylinder and a cam chamber in which a cam for driving an intake valve and an exhaust valve is placed.

Generally, in an engine, a cam chamber (communicating with a crank chamber) in which blow-by gas (unburned gas leaking from a cylinder) is stored is connected to an intake system through a blow-by gas ventilation passage connected to the crank chamber or a blow-by gas ventilation passage directly connected to the cam chamber, and thus unburned gas leaking from the cylinder into the cam chamber is returned to the intake system. Thus, the decompression hole communicates with the cam chamber as described above, thereby allowing unburned gas leaking from a combustion chamber through the decompression hole to be returned into the cylinder through an intake system and burned. This can prevent unburned gas from being exhausted when the engine is started in the manual start mode.

### BRIEF DESCRIPTION OF THE DRAWINGS

The above and other objects and features of the invention will be apparent from the detailed description of the preferred embodiments of the invention, which is described and illustrated with reference to the accompanying drawings, in which;

FIG. 1 is a schematic block diagram of a construction of hardware of an engine system to which a starting device according to the present invention is applied;

FIG. 2 is a block diagram of an electrical construction of the system in FIG. 1;

FIG. 3 is a sectional view of essential portions of the engine in FIG. 1;

FIG. 4 is a block diagram of a construction of the engine starting device according to the present invention;

FIGS. 5A to 5E are schematic waveform charts showing waveforms of output pulses of a signal generator and waveforms of output signals of Hall sensors used in the embodiment of the present invention;

FIG. 6 is a flowchart of an algorithm of a processing performed by a microprocessor for comprising a start mode switching portion and a manual start time fuel injection control portion in the embodiment of the present invention;

FIG. 7 is a flowchart of an algorithm of a processing performed by the microprocessor for comprising a battery capacity monitoring portion in the embodiment of the present invention;

FIG. 8 is a flowchart of an algorithm of a processing performed by the microprocessor for comprising a start time ignition control portion in the embodiment of the present invention;

FIG. 9 is a flowchart of an algorithm of a processing performed by the microprocessor for causing multiple ignition in the embodiment of the present invention;

FIG. 10 is a flowchart of an ignition timer interruption processing performed in the multiple ignition in the embodiment of the present invention; and

FIG. 11 is a flowchart of an algorithm of a processing performed by a microprocessor for comprising a start mode switching portion, a manual start time fuel injection control portion, and a starter assisting portion in another embodiment of the present invention.

### DETAILED DESCRIPTION OF THE PREFERRED EMBODIMENTS

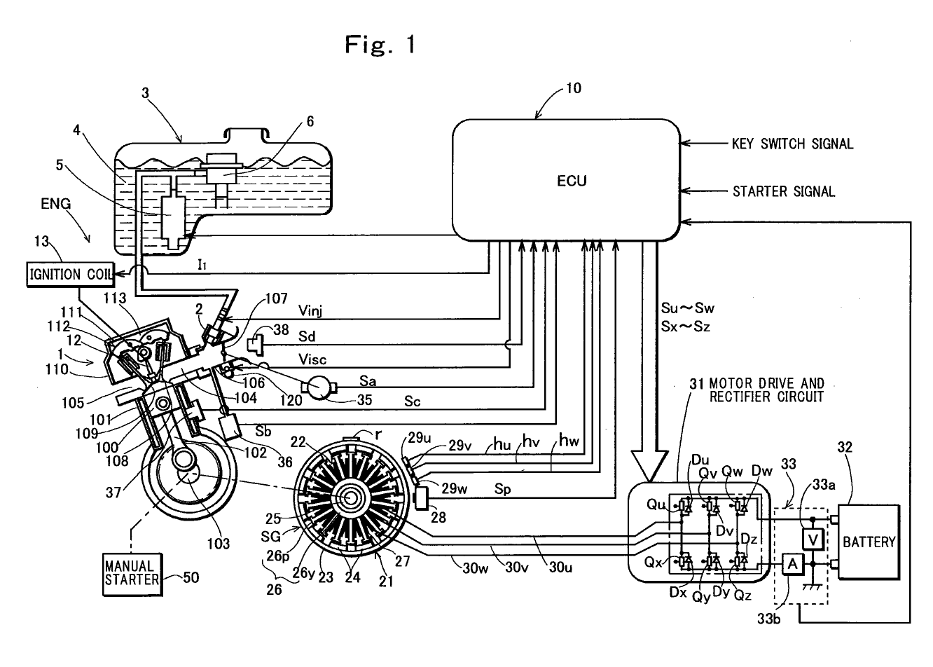

Now, preferred embodiments of the present invention will be described with reference to FIGS. 1 to 11.

FIG. 1 shows a construction of an engine system including an engine starting device according to the present invention. In FIG. 1, ENG denotes a parallel two cylinder four cycle engine. Combustion cycles of a first cylinder and a second cylinder of the engine have a phase difference of 360°. A reference numeral 1 denotes an engine body, which includes two cylinders 101 (the first cylinder only is shown) having a piston 100 therein, and a crankshaft 103 connected to the piston 100 in the cylinder via a connecting rod 102.

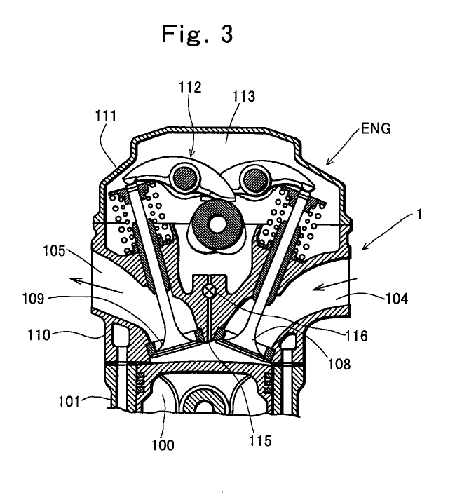

As shown in FIG. 3, the engine body 1 includes an intake port 104 and an exhaust port 105, and an intake pipe 106 is connected to the intake port 104. A throttle valve 107 is provided in the intake pipe 106, and an intake valve 108 and an exhaust valve 109 are provided so as to open and close the intake port 104 and the exhaust port 105, respectively. A cam cover 111 is mounted to an upper portion of a cylinder head 110 of the engine body, and inside the cam cover 111, a cam chamber 113 housing a cam mechanism 112 for driving the intake valve 108 and the exhaust valve 109 is provided.

In the embodiment, there are provided a decompression hole 115 (see FIG. 3) and a decompression valve 116 comprised of a solenoid valve that can be controlled to open and close the decompression hole 115 so as to provide communication between each cylinder 101 and the cam chamber 113. Also, a decompression valve control portion is provided that controls the decompression valve 116 so as to be opened at the start of the engine and closed after initial explosion of the engine.

In the embodiment, the intake pipe 104 is provided for each cylinder of the engine, but the starting device according to the present invention may be applied to the case where one common intake pipe is provided for a plurality of cylinders.

The engine ENG includes a fuel injection device that injects fuel for generating an air/fuel mixture to be supplied into the cylinder 101 through the intake pipe 106, an ignition device that ignites the air/fuel mixture compressed in the cylinder 101, and a starter motor that can rotationally drive the crankshaft 103 in forward and reverse directions.

In the shown example, an injector (electromagnetic fuel injection valve) 2 is mounted so as to inject fuel into an intake pipe or an intake port downstream of the throttle valve 107. The injector 2 is a known one including an injector body having an injection hole at a tip thereof, a needle valve that opens and closes the injection hole, and a solenoid that drives the needle valve. Fuel is supplied into the injector body from a fuel pump 5 that pumps fuel 4 in a fuel tank 3. A pressure of the fuel supplied from the fuel pump 5 to the injector 2 is maintained constant by a pressure regulator 6. The solenoid of the injector 2 is connected to an injector drive circuit provided in an electronic control unit (ECU) 10. The injector drive circuit supplies a driving voltage to the solenoid of the injector 2 when an injection command signal is generated in the ECU. The injector 2 opens the valve while a driving voltage Vinj is supplied from the injector drive circuit to the solenoid and injects fuel into the intake pipe. When the pressure of the fuel supplied to the injector is maintained constant, an injection amount of the fuel is controlled by an injection time (a time during which the valve of the injector is opened).

In this example, the fuel injection device is comprised of the injector 2, the unshown injector drive circuit, fuel injection control portion that gives an injection command to the injector drive circuit, and the fuel pump 5.

As shown in FIG. 1, to the cylinder head of the engine body, an ignition plug 12 for each cylinder is mounted with a discharge gap at a tip thereof facing a combustion chamber in each cylinder 101. The ignition plug for each cylinder is connected to a secondary side of an ignition coil 13 for each cylinder. A primary side of the ignition coil 13 for each cylinder is connected to an unshown ignition circuit provided in the ECU 10.

The ignition circuit is a circuit that suddenly changes a primary current I1 of the ignition coil 13 to induce a high voltage for ignition on the secondary side of the ignition coil 13 when an ignition command is given from an ignition command issuing portion. The ignition device that ignites the engine is comprised of the ignition plug 12, the ignition coil 13, the unshown ignition circuit, and the ignition command issuing portion that gives the ignition command to the ignition circuit.

The ignition command issuing portion is comprised of a normal time ignition control portion that arithmetically operates an ignition position during normal operation of the engine and issues an ignition command when the arithmetically operated ignition position is detected, and a start time ignition control portion that issues an ignition command at an ignition position suitable for starting the engine at the start of the engine.

In the engine in FIG. 1, an ISC (Idle Speed Control) valve 120 is provided that is operated by the solenoid so as to bypass the throttle valve. An ISC valve drive circuit that provides a drive signal Visc to the ISC valve 120 is provided in the ECU 10, and the drive signal Visc is provided from the ISC valve drive circuit to the ISC valve 120 so as to maintain a constant idling speed of the engine.

In the embodiment, a rotating electric machine (referred to as a starter generator) SG, which is driven as a starter motor at the start of the engine and operated as a generator after the start of the engine, is mounted to the engine, and the rotating electric machine SG is used as a starter motor. The rotating electric machine SG is comprised of a rotor 21 mounted to the crankshaft 103 of the engine, and a stator 22 secured to a case or the like of the engine body.

The rotor 21 is comprised of a cup-like ferrous rotor yoke 23, and permanent magnets 24 mounted to an inner periphery thereof. In this example, the permanent magnets 24 mounted to the inner periphery of the rotor yoke 23 produce 12-pole magnetic fields. The rotor 21 is mounted to the crankshaft 103 by fitting a tapered portion at a tip of the crankshaft 103 of the engine in a tapered hole formed in a boss 25 provided at the center of a bottom wall portion of the rotor yoke 23, and fastening the boss 25 to the crankshaft 103 by a screw member.

The stator 22 is comprised of a stator iron core 26 having a structure with 18 salient pole portions 26p radially protruding from an outer periphery of an annular yoke 26y, and an armature coil 27 wound around the series of salient pole portions 26p of the stator iron core and three-phase connected, and a magnetic pole portion at a tip of each salient pole portion 26p of the stator iron core 26 faces a magnetic pole portion of the rotor with a predetermined gap therebetween. A reluctor r constituted by an arcuate protrusion is formed on an outer periphery of the rotor yoke 23, and a signal generator 28 that detects a leading edge and a trailing edge in a rotational direction of the reluctor r to generate pulses having different polarities is mounted to a case side of the engine.

Hall sensors 29u to 29w such as Hall ICs, which are placed in detection positions set for the three-phase armature coils and detect polarities of the magnetic poles of the magnetic fields of the rotor 21, are provided on a stator side of the starter generator SG. In FIG. 1, the three-phase Hall sensors 29u to 29w are shown placed outside the rotor yoke 23, but actually, the three-phase Hall sensors 29u to 29w are placed inside the rotor 21 and mounted to a printed circuit board secured to the stator 22. The Hall sensors are provided in the same manner as in a general three-phase brushless motor. The Hall sensors 29u to 29w output position detection signals hu to hw that are voltage signals having different levels between when the detected magnetic pole is a north pole and when the detected magnetic pole is a south pole.

The three-phase armature coils of the starter generator SG are connected to AC terminals of a motor drive and rectifier circuit 31 through wires 30u to 30w, and a battery 32 is connected across DC terminals of the motor drive and rectifier circuit 31. The motor drive and rectifier circuit 31 is a known circuit comprising a bridge type three-phase inverter circuit (motor drive circuit) in which switch elements Qu to Qw and Qx to Qz that can be controlled on/off such as MOSFETs or power transistors form sides of a three-phase H bridge, and a diode bridge three-phase full-wave rectifier circuit comprised of diodes Du to Dw and Dx to Dz connected in anti-parallel with the switch elements Qu to Qw and Qx to Qz of the inverter circuit.

When the starter generator SG is operated as the starter motor, the switch elements of the inverter circuit are controlled on/off according to a rotational angle position of the rotor 21 detected from outputs of the Hall sensors 29u to 29w, and thus a driving current that is commutated in a predetermined phase order is supplied from the battery 32 through the inverter circuit to the three-phase armature coil 27.

When the starter generator SG is operated as the generator after the start of the engine, a three-phase AC output obtained from the armature coil 27 is supplied through the full-wave rectifier circuit in the motor drive and rectifier circuit 31 to the battery 32 and various loads (not shown) connected across the battery 32. At this time, the switch elements that form an upper side or a lower side of the bridge of the inverter circuit are simultaneously controlled on/off according to the voltage across the battery 32, and thus the voltage across the battery 32 is controlled so as not to exceed a set value.

For example, when the voltage across the battery 32 is the set value or less, the switch elements Qu to Qw and Qx to Qz that form the H bridge of the inverter circuit are maintained in an off state, and the output of the rectifier circuit in the motor drive and rectifier circuit 31 is applied as it is to the battery 32.

When the voltage across the battery 32 exceeds the set value, the three switch elements Qx to Qz that form three lower sides (or upper sides) of the bridge of the inverter circuit are simultaneously turned on, and thus the three-phase AC output of the generator is short-circuited to reduce the voltage across the battery 32 to the set value or less. Repeating these operations allows the voltage across the battery 32 to be maintained at around the set value.

Instead of the above described control, it may be allowed that means for controlling the inverter circuit is provided so as to apply an AC control voltage having the same frequency as an induced voltage of the armature coil of the starter generator SG and having a predetermined phase angle relative to an induced voltage at the time of no-load of the armature coil, from the battery 32 through the inverter circuit to the armature coil of the starter generator SG, and the phase of the AC control voltage is changed relative to the no-load induced voltage of the armature coil according to changes in the voltage across the battery, thereby increasing or reducing generation outputs of the rotating electric machine to maintain the voltage across the battery 32 within a set range.

When MOSFETs are used as the switch elements that form the sides of the bridge of the inverter circuit, parasitic diodes formed between drains and sources of the MOSFETs can be used as the diodes Du to Dw and Dx to Dz.

In order to detect the state of the battery 32, a battery state detection portion 33 is provided comprised of a battery voltage detection portion 33a that detects the voltage across the battery 32 and an output current detection portion 33b that detects an output current of the battery 32, and a voltage detection signal and a current detection signal obtained from the voltage sensor 33a and the current sensor 33b, respectively, are provided to a microprocessor (MPU) in the ECU 10. The battery state detection portion 33 comprises part of a battery capacity monitoring portion described later.

In the shown example, in order to provide information on the engine to the microprocessor in the ECU 10, there are provided a throttle position sensor 35 that detects a position (an opening degree) of the throttle valve 107, a pressure sensor 36 that detects an internal pressure of an intake pipe downstream of the throttle valve 107, a cooling water temperature sensor 37 that detects a cooling water temperature of the engine, and an intake air temperature sensor 38 that detects a temperature of air taken in by the engine, and outputs of the sensors are provided to the ECU 10.

As described above, in the embodiment, the rotor of the starter generator SG is directly connected to the crankshaft of the engine, the starter generator is used as the starter motor at the start of the engine, and the starter generator is used as the generator after the start of the engine. In the following description on the engine starting device, the starter generator SG is simply referred to as the starter motor in some cases for convenience because the description is directed to control when the starter generator SG is operated as the starter motor.

In the embodiment, in order to start the engine ENG, a manual starter 50 that is manually driven to perform cranking of the engine to start the engine is provided besides the electric starter comprised of the starter generator. The manual starter 50 is comprised of a recoil starter that performs cranking of an engine by pulling a rope by hand, or a kick starter that performs cranking of the engine by depressing a kick pedal by foot, and is operated by operator's hand or foot to perform cranking of the engine.

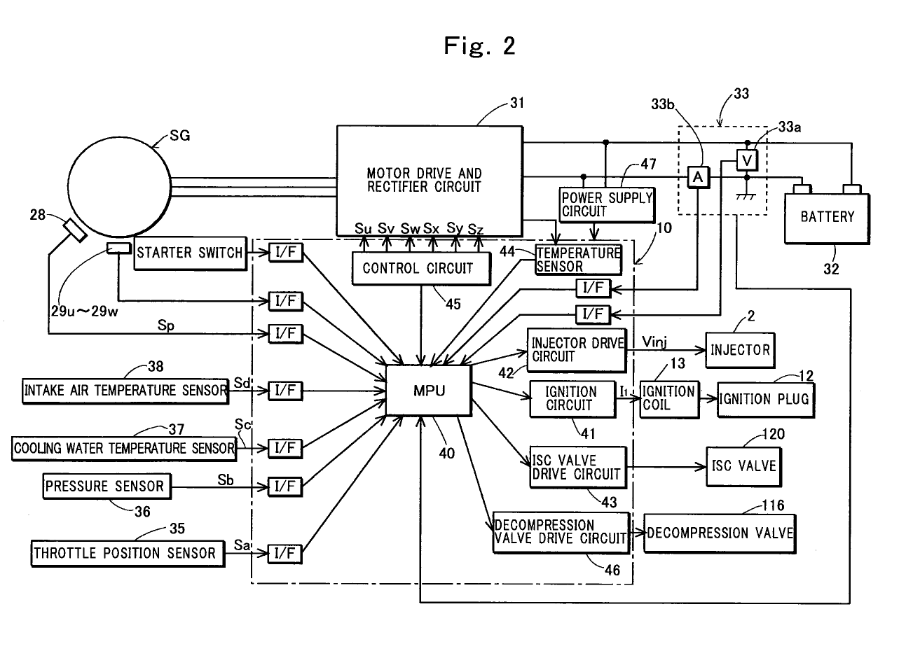

FIG. 2 is a block diagram of an electrical construction of the system in FIG. 1. The ECU 10 comprises a microprocessor (MPU) 40, an ignition circuit 41, an injector drive circuit 42, an ISC valve drive circuit 43, a temperature sensor 44 that detects a temperature of the motor drive and rectifier circuit 31, a control circuit 45 that provides drive signals to the switch elements of the inverter circuit of the motor drive and rectifier circuit 31 according to commands given from the microprocessor 40, a decompression valve drive circuit 46 that supplies a driving current to the decompression valve 116, and a predetermined number of interface circuits I/F.

The microprocessor 40 performs predetermined programs stored in a ROM to comprise various control portions required for controlling the engine. In the shown example, in order to provide information on the engine to the microprocessor, a throttle position signal Sa obtained from the throttle position sensor 35, an intake pipe internal pressure detection signal Sb obtained from the pressure sensor 36, a cooling water temperature detection signal Sc obtained from the cooling water temperature sensor 37, and an intake air temperature detection signal Sd obtained from the intake air temperature sensor 38 are input to the microprocessor in the ECU 10 through the interface circuits I/F. The output signals hu to hw of the Hall sensors 29u to 29w, an output Sp of the signal generator 28, the voltage detection signal and the current detection signal obtained from the voltage sensor 33a and the current sensor 33b are input to the microprocessor 40 through predetermined interface circuits I/F.

The ignition circuit 41 in the ECU 10 supplies the primary current I1 to the ignition coil 13, and the injector drive circuit 42 supplies the driving voltage Vinj to the injector 2. The control circuit 45 provides drive signals (signals for turning on the switch elements) Su to Sw and Sx to Sz to the six switch elements Qu to Qw and Qx to Qz, respectively, of the inverter circuit of the motor drive and rectifier circuit 31.

In FIG. 2, a reference numeral 47 denotes a power supply circuit to which an output voltage of the battery 32 is input. The power supply circuit 47 reduces and stabilizes the output voltage of the battery 32 to output a power supply voltage to be supplied to each component of the ECU 10.

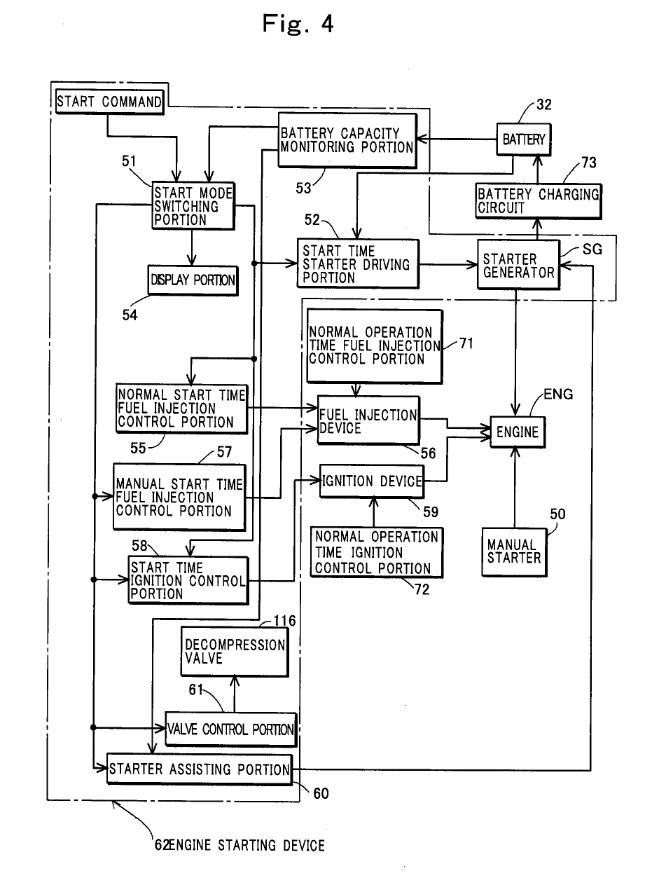

FIG. 4 shows a construction of the engine starting device including various control portions comprised by the microprocessor 40 in the embodiment. In FIG. 4, reference numeral 51 denotes a start mode switching portion that switches a start mode of the engine between a normal start mode (a mode in which the engine is started by the starter motor) and a manual start mode (a mode in which the engine is started by the manual starter), and 52 denotes a start time starter driving portion that operates the starter generator SG as the starter motor and supplies the driving current from the battery 32 to the starter generator SG according to the outputs of the Hall sensors 29u to 29w for causing the cranking of the engine when the start mode is the normal start mode. A reference numeral 53 denotes a battery capacity monitoring portion that estimates a remaining capacity of the battery 32 that supplies the driving current to the starter generator SG, and 54 denotes a display portion that displays that the cranking for starting the engine is to be performed by the manual starter 50 when the start mode is switched to the manual start mode.

The start mode switching portion 51 is comprised so as to set the start mode to the normal start mode and cause the start time starter driving portion 52 to start supplying the driving current to the starter generator when a start command of the engine is given, then keep the start mode of the engine in the normal start mode when the remaining capacity of the battery estimated by the battery capacity monitoring portion 53 is checked and the remaining capacity of the battery is equal to or larger than a capacity required for the starter generator SG to start the engine, and prohibit the driving of the starter motor by the starter driving portion 52 and switch the start mode of the engine to the manual start mode when the remaining capacity of the battery estimated by the battery capacity monitoring portion 53 is smaller than the capacity required for starting the engine.

The battery capacity monitoring portion 53 detects the output voltage and the output current (driving current passed from the battery to a load) of the battery 32, and estimates the remaining capacity of the battery. Various methods for estimating the remaining capacity of the battery are known, and in the present invention, it is only necessary to estimate the remaining capacity of the battery by any method. In the embodiment, the remaining capacity of the battery is estimated from a relationship between the battery voltage, the output current of the battery, and the remaining capacity of the battery. Thus, the battery capacity monitoring portion 53 used in the embodiment is comprised of the battery voltage detection portion 33a that detects the voltage across the battery, the output current detection portion 33b that detects the output current of the battery 32, a remaining capacity estimating determined value arithmetical operation portion that arithmetically operates a determined value to be compared with a detected value of the battery voltage for estimating the remaining capacity of the battery, with respect to the output current of the battery detected by the output current detection portion 33b, and a battery capacity estimation portion that compares the detected value of the battery voltage detected by the battery voltage detection portion with the determined value, estimates that the remaining capacity of the battery is equal to or larger than a capacity required for starting the engine when the detected battery voltage is the determined value or more, and estimates that the remaining capacity of the battery is smaller than the capacity required for starting the engine when the detected battery voltage is less than the determined value (the capacity of the battery is insufficient). Among the components of the battery capacity monitoring portion 53, the remaining capacity estimating determined value arithmetical operation portion and the battery capacity estimation portion are comprised by the microprocessor 40.

The start time starter driving portion 52 provides drive signals to the switch elements that form the motor drive and rectifier circuit 31 to rotate the rotor of the starter generator so that when the start mode is the normal start mode, the driving current that is commutated in a predetermined phase order is passed through the three-phase armature coil of the starter generator SG according to a rotational angle position of the rotor detected by the Hall sensors 29u to 29w to rotate the starter generator in a predetermined direction according to a cranking pattern at the start of the engine. The starter generator is driven as the starter motor in the same manner as a three-phase brushless motor.

Known cranking patterns (the manners of rotating the crankshaft) at the start of the engine include a pattern of rotating the crankshaft in a start direction (forward rotation direction of the engine) from the beginning when the start command is given, and a pattern of once rotating the crankshaft in a direction reverse to the start direction, then reversing the rotational direction of the crankshaft, and rotating the crankshaft in the start direction when the start command is given. In the present invention, the cranking at the normal start may be performed by either of the cranking patterns, but in the embodiment, the crankshaft is rotated in the start direction (forward direction) from the beginning when the start command is given.

The display portion 54 displays by any means that the engine is to be started by using the manual starter 50 when the battery capacity monitoring portion 53 estimates that the capacity of the battery is insufficient for the starter generator to start the engine. The means for displaying that the engine is to be started by using the manual starter 50 includes means for causing light emitting display means such as an LED (a light emitting diode) to emit light when the capacity of the battery is insufficient, means for displaying a message of an instruction to start the engine by the manual starter on a display such as a liquid crystal display, or means for making a voice notification that the engine is to be started by using the manual starter.

In FIG. 4, a reference numeral 55 denotes a normal start time fuel injection control portion that controls a fuel injection device 56 comprised of the injector 2, the fuel pump 5, and the injector drive circuit 42 when the start mode is the normal start mode (the mode in which the engine is started by the starter motor), and 57 denotes a manual start time fuel injection control portion that controls the fuel injection device 56 when the start mode is the manual start mode.

The normal start time fuel injection control portion 55 starts driving the fuel pump 5 of the fuel injection device 56 immediately after the start command is given, and provides the injection command signal Vinj to the injector drive circuit 42 to cause first fuel injection after the commencement of the starting operation when a driving time of the fuel pump reaches a set time. The normal start time fuel injection control portion 55 also provides an injection command signal to the injector drive circuit to cause fuel injection every time a predetermined fuel injection start position (generally, a position immediately before a crank angle position where an intake stroke is started) is detected after the first fuel injection.

The manual start time fuel injection control portion 57 is comprised so as to start driving the fuel pump of the fuel injection device immediately after the manual starter 50 is operated and the manual start is commenced with the start mode being switched to the manual start mode, cause first fuel injection after the commencement of the starting operation when a driving time of the fuel pump reaches a set time, and thereafter provide an injection command signal to the injector drive circuit to cause fuel injection every time the predetermined fuel injection start position is detected.

A reference numeral 58 denotes a start time ignition control portion that controls an ignition device 59 comprised of the ignition coil 13 and the ignition circuit 41 at the start of the engine, 60 denotes a starter assisting portion that drives the starter generator as the motor to assist the cranking by the manual starter at the manual start, and 61 denotes a valve control portion that controls the decompression valve 116 at the manual start.

The start time ignition control portion 58 controls the ignition device so as to ignite the engine at a crank angle position at which the piston of the engine reaches the top dead center of the compression stroke or a crank angle position delayed from the crank angle position at which the piston of the engine reaches the top dead center of the compression stroke between the commencement of the starting operation of the engine and the completion of the start of the engine.

The pulse signal generator 28 in FIG. 1 can generate a pulse signal having a level of a threshold or more only when the engine rotates at a rotational speed of at least about 100 r/min. On the other hand, the Hall sensors 29u to 29w provided in the starter generator can detect crank angle information even at an extremely low rotational speed. Thus, in the embodiment, in order to obtain the crank angle information and rotational position information of the engine even at the start by the manual starter without trouble, the start time ignition control portion 58, the normal start time fuel injection control portion 55, and the manual start time fuel control portion 57 are comprised so as to obtain the rotational position information and the crank angle information of the engine required for control from the outputs of the Hall sensors 29u to 29w provided in the starter generator.

In the embodiment, the crank angle information is basically obtained from the detection signals outputted from the three-phase Hall sensors 29u to 29w provided in the starter generator both at the start and during the normal operation of the engine, and the output pulse of the signal generator 28 is used only for identifying which of the crank angle positions of the engine the rotational angle position detected from the outputs of the Hall sensors corresponds to.

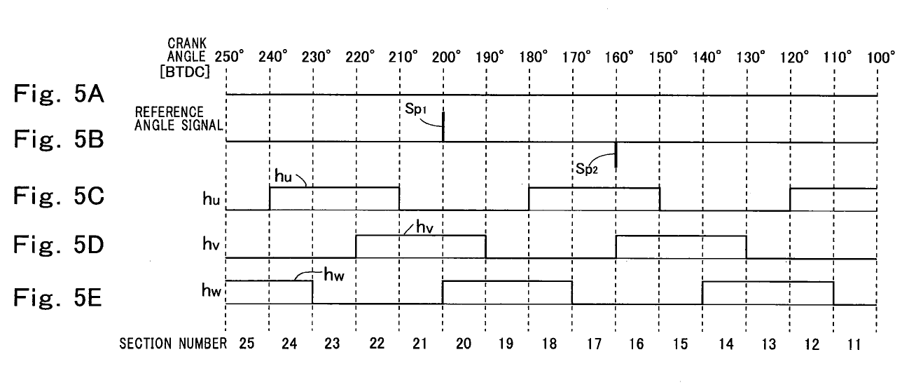

In the case where a 12-pole (6 pairs of poles) magneto rotor is used as the rotor of the starter generator, when Hall ICs are used as the three-phase Hall sensors 29u to 29w, the sensors 29u to 29w generate the position detection signals hu to hw having waveforms as shown in FIGS. 5C to 5E, and any of the position detection signals hu to hw changes from a high level (H level) to a low level (L level) or from the low level to the high level for every 10° change of the crank angle. In the embodiment, the H level and the L level of the position detection signals hu to hw are indicated by “1” and “0”, a series of sections are detected, with a 10° section as one section, from changes in level pattern of the position detection signal, and it is identified which of the crank angle positions of the engine these sections correspond to by using the output pulse of the signal generator 28.

In the embodiment, the signal generator 28 is provided so as to detect the reluctor r to generate a pulse when the piston is located near the bottom dead center, that is, in a section where load torque of the engine is relatively low so that the signal generator 28 can generate a pulse with as high peak value as possible at the start. Specifically, as shown in FIG. 5B, the signal generator 28 is placed so as to detect a leading edge and a trailing edge in the rotational direction of the reluctor r to generate a pulse Sp1 having a positive polarity and a pulse Sp2 having a negative polarity at positions of 200° and 160° before the top dead center of the compression stroke of the second cylinder.

In the embodiment, it is identified which of the crank angle positions of the engine the series of sections detected by changes in output pattern of the Hall sensors correspond to, from the pulses Sp1 and Sp2 outputted by the signal generator 28. In the shown example, as indicated at the bottom in FIG. 5, a section of 10° (a section from a position where the pattern of the position detection signals hu, hv, hw is 0, 1, 1 to a position where the pattern is 0, 0, 1) detected immediately after the signal generator 28 generates the pulse Sp1 is denoted by a section number “20”, and thereafter the section number is changed by one for every change in the output pattern of the Hall sensors, and 72 sections detected during two turns of the crankshaft are denoted by section numbers 1 to 72.

If a relationship between the series of sections detected from the changes in the output pattern of the Hall sensors and the present crank angle position of the engine can be once identified, thereafter the section number can be changed for every change in the output pattern of the Hall sensor to maintain the relationship between each section and the crank angle position of the engine.

The starter assisting portion 60 is comprised so as to obtain information on the battery voltage from the battery capacity detection portion 53 to monitor the voltage of the battery 32 and drive the starter generator SG as the motor as far as the battery voltage is equal to or higher than a voltage value required for operating the ignition device 59 and the fuel injection device 56 to assist the cranking of the engine by the manual starter 50 when the manual starter 50 performs the cranking of the engine.

The valve control portion 61 controls the decompression valve 116 so as to be opened when the manual starter 50 is operated to commence the starting operation in the manual start mode, and closed when the starting operation of the engine is completed, with the start mode being switched to the manual start mode.

In this example, the engine starting device 62 is comprised of the starter generator SG, the manual starter 50, the start mode switching portion 51, the start time starter driving portion 52, the battery capacity monitoring portion 53, the display portion 54, the normal start time fuel injection control portion 57, the start time ignition control portion 58, the starter assisting portion 60, and the valve control portion 61.

Among the components of the engine starting device 62, components other than those provided as hardware are comprised by the microprocessor 40 provided in the ECU 10 in FIGS. 1 and 2 performing predetermined programs. The microprocessor in the ECU 10 also comprises various means for performing control required for operating the engine such as a normal operation time fuel injection control portion 71 that controls the fuel injection device 56 during the normal operation of the engine, and a normal operation time ignition control portion 72 that controls the ignition device 59 during the normal operation of the engine.

In the embodiment, in order to operate the starter generator as the magneto generator to charge the battery 32 by a generated output thereof after the start of the engine, a battery charging circuit 73 is provided that controls a charging current supplied from the starter generator to the battery 32.

When a start command is given by an operation of an unshown key switch or the like in the engine starting device 62 in FIG. 4, the start mode switching portion 51 first sets the start mode to the normal start mode. At this time, the driving current is supplied to the starter generator SG so that the start time starter driving portion 52 drives the starter generator as the starter motor. Thus, the starter generator rotates, and the crankshaft of the engine rotates forward. When the driving of the starter generator as the starter motor is started, the battery capacity monitoring portion 53 first estimates the remaining capacity of the battery 32. When it is estimated that the remaining capacity of the battery is sufficient, the driving of the starter generator as the starter motor is continued. When the cranking by the starter generator is started, the normal start time fuel injection control portion 55 starts driving the fuel pump 5, and provides the injection command signal to the injector drive circuit 42 when the driving time of the fuel pump reaches a certain time. Thus, the injector 2 injects fuel into the intake pipe of the engine. The normal start time fuel injection control portion 55 thereafter provides the injection command signal to the injector drive circuit 42 to cause the injector to inject fuel every time the predetermined fuel injection start position is detected from the outputs of the Hall sensors.

When the crank angle position of the engine reaches an energization start position set to a position advanced from the ignition position at the start, the microprocessor 40 provides an energization start signal to the ignition circuit 41. At this time, the ignition circuit 41 passes the primary current from the battery 32 through the ignition coil 13. Then, when it is detected that the crank angle position of the engine matches the ignition position at the start, the microprocessor provides an ignition signal to the ignition circuit 41. At this time, the ignition circuit 41 interrupts the primary current having passed through the ignition coil 13, and induces a high voltage for ignition in a secondary coil of the ignition coil 13. This causes spark in the ignition plug mounted to the cylinder of the engine to ignite the engine. When the ignition causes initial explosion, the engine is started to accelerate the crankshaft.

As in the embodiment, in the case where the crankshaft is rotated forward to perform the cranking from the beginning when the start command is given, an air/fuel mixture cannot be supplied into a cylinder that first enters the compression stroke in a first turn of the crankshaft after the start command is given, and thus combustion (initial explosion) cannot be performed in the cylinder though the ignition is performed therein. On the other hand, to a cylinder that enters the compression stroke in a second turn of the crankshaft, the air/fuel mixture can be supplied into the cylinder by causing first fuel injection in an appropriate section. Thus, the ignition is performed in a rotational angle position of the crankshaft that is a position suitable as an ignition position of the cylinder that enters the compression stroke in the second turn of the crankshaft after the commencement of the starting operation, thereby allowing the engine to be started without trouble.

In the embodiment, the ignition position at the start of each cylinder of the engine is set to the crank angle position (referred to as a top dead center position) where the piston in each cylinder reaches the top dead center of the compression stroke, or the crank angle position slightly delayed from the top dead center position. As described later, in the embodiment, after the first ignition is performed in the ignition position at the start of the engine, multiple ignition that is ignition repeatedly performed at short time intervals is performed to ensure initial explosion of the engine. The microprocessor finishes the start mode when detecting that the start of the engine is completed from the rotational speed of the engine, and shifts the control mode of the engine to the normal mode.

When the start command is given, the starter generator is driven as the motor to start the cranking of the engine, and then the battery capacity monitoring portion 53 estimates that the remaining capacity of the battery 32 is insufficient, the start mode switching portion immediately prohibits the driving of the starter generator as the starter motor and switches the start mode to the manual start mode. Thus, when it is estimated that the capacity of the battery is insufficient after the start of the cranking of the engine, the driving of the starter generator is immediately stopped, thereby preventing the battery from being excessively exhausted. At this time, the start mode switching portion 51 switches the start mode to the manual start mode, and the display portion 54 displays that the engine is to be started by the manual starter by causing the LED to emit light or the like.

Even when the remaining capacity of the battery is insufficient for the starter motor to start the engine, generally, the ignition device 59 and the fuel injection device 56 can be driven by the manual start. Thus, the driving of the starter generator as the starter motor is stopped to perform the manual start so as to prevent the battery from being excessively exhausted, thereby allowing the engine to be started. Thus, comprised as the present invention, a situation where the engine cannot be completely started can be avoided, taking the advantage of providing the manual starter together with the electric starter.

When the display portion 51 displays that the engine is to be started by the manual starter, a driver operates the manual starter 50 such as a recoil starter to perform the cranking for starting the engine. When the manual start is commenced, the manual start time fuel injection control portion 57 starts driving the fuel pump 5 of the fuel injection device 56, and causes the first fuel injection after the commencement of the starting operation when the driving time of the fuel pump reaches a set time. The manual start time fuel injection control portion 57 thereafter provides the injection command signal Vinj to the injector drive circuit 42 to cause fuel injection every time the predetermined fuel injection start position is detected.

In the embodiment, when the manual starter 50 performs the cranking of the engine, the starter assisting portion 60 monitors the voltage of the battery 32, and drives the starter generator as the motor as far as the battery voltage is equal to or higher than the voltage value required for operating the ignition device and the fuel injection device to assist the cranking by the manual starter. This reduces an operation force applied to the manual starter by the driver for performing the cranking, increases a cranking speed, and improves startability of the engine.

When the crank angle position of the engine matches the ignition position at the start while the manual starter performs the cranking, the start time ignition control portion 58 causes the ignition operation. This causes the initial explosion to start the engine.

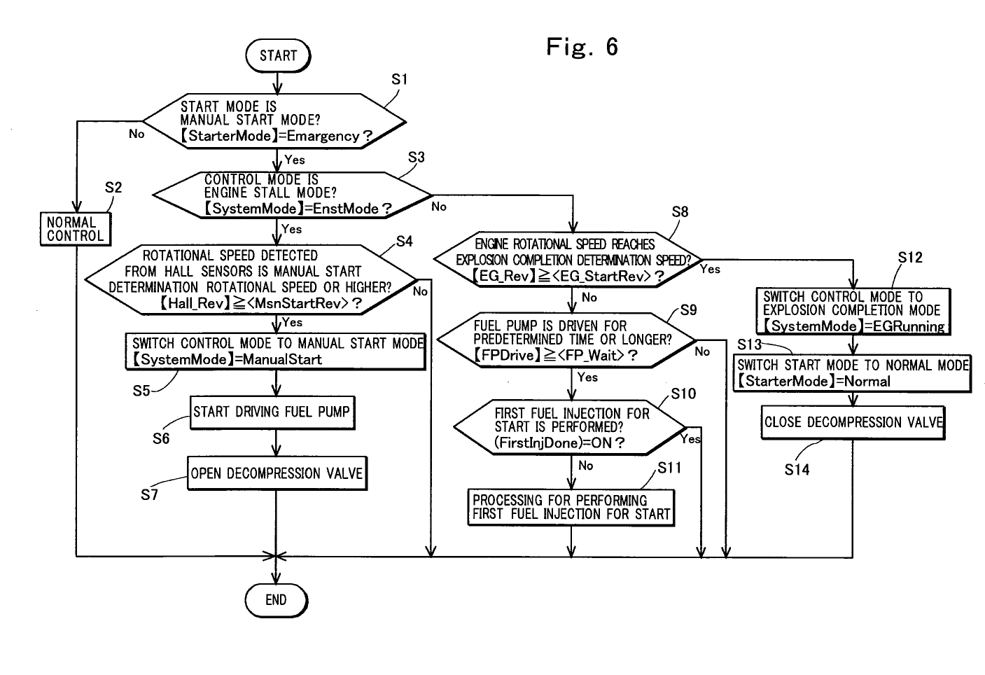

FIGS. 6 to 10 show flowcharts of algorithms of programs performed by the microprocessor 40 for comprising the components of the engine starting device 62 in FIG. 4.

After the microprocessor 40 is powered on, the microprocessor 40 performs a task processing in FIG. 6 every time the pattern of the output signals of the Hall sensors 29u to 29w is switched (every time the section number changes). When the processing in FIG. 6 is started, first in Step S1, it is determined whether the start mode is the manual start mode ([Starter Mode]=Emergency?). When the microprocessor is powered on, the start mode is the normal start mode. Thus, in Step S1, it is determined that the start mode is not the manual start mode, and the process moves to Step S2. In Step S2, the driving current is supplied to the starter generator SG so as to drive the starter generator as the starter motor with the start mode being the normal start mode.

When it is determined in Step S1 that the start mode is the manual start mode, the process moves to Step S3, and it is determined whether the control mode is an engine stall mode (a mode at the stop of the engine) ([System Mode]=Enst Mode?). When it is determined that the control mode is the engine stall mode (it is determined that the engine is stopped), the process proceeds to Step S4, and it is determined whether a rotational speed (a rotational speed when the driver performs the cranking by the manual starter) of the engine detected from the output pulses of the Hall sensors provided in the starter generator is a manual start determination speed or higher ([Hall_Rev]≧<Manual Start>?). The manual start determination speed is a rotational speed for determining that the starting operation of the engine by the manual starter is commenced.

When it is determined in Step S4 that the rotational speed does not reach the manual start determination speed, this processing is finished without performing any processing thereafter. When it is determined in Step S4 that the rotational speed reaches the manual start determination speed, the process proceeds to Step S5, and a processing for switching the control mode to the manual start mode ([System Mode]=Manual Start) is performed. Then, in Step S6, the driving of the fuel pump is started, and in Step S7, the decompression valve 116 is opened, and this processing is finished.

When it is determined in Step S3 that the present control mode is not the engine stall mode (the engine is rotating), the process moves to Step S8, and a processing for determining whether the rotational speed of the engine reaches an explosion completion determination speed (a rotational speed for determining that the initial explosion of the engine is completed) ([EG_Rev]≧<FP_Wait>?) is performed. When it is determined that the rotational speed of the engine does not reach the explosion completion determination speed (it is determined that the initial explosion of the engine is not completed), the process proceeds to Step S9, and a processing for determining whether the fuel pump is driven for a predetermined time or longer ([FP Drive]≧<FP_Wait>?). When it is determined that the fuel pump is not driven for the predetermined time or longer, this processing is finished without performing any processing thereafter. When it is determined in Step S9 that the fuel pump is driven for the predetermined time or longer, the process proceeds to Step S10, and it is determined whether the first fuel injection for the start is finished (First Injection=ON?). When it is determined that the first fuel injection for the start is not finished, the process proceeds to Step S11, and a processing for performing the first fuel injection for the start is performed. The processing for performing the first fuel injection for the start is a processing for providing an injection command signal Vinj having a predetermined time width to the injector drive circuit 42. When it is determined in Step S10 that the first fuel injection for the start is finished, this processing is finished without performing any processing thereafter.

When it is determined in Step S8 in the processing in FIG. 6 that the rotational speed of the engine reaches the explosion completion determination speed (the initial explosion of the engine is completed), the process proceeds to Step S12, and a processing for switching the control mode to an explosion completion mode ([System Mode]=EG Running) is performed. Then, in Step S13, a processing for switching the start mode to the normal mode ([Start Mode]=Normal) is performed, and in Step S14, the decompression valve is closed, and then this processing is finished.

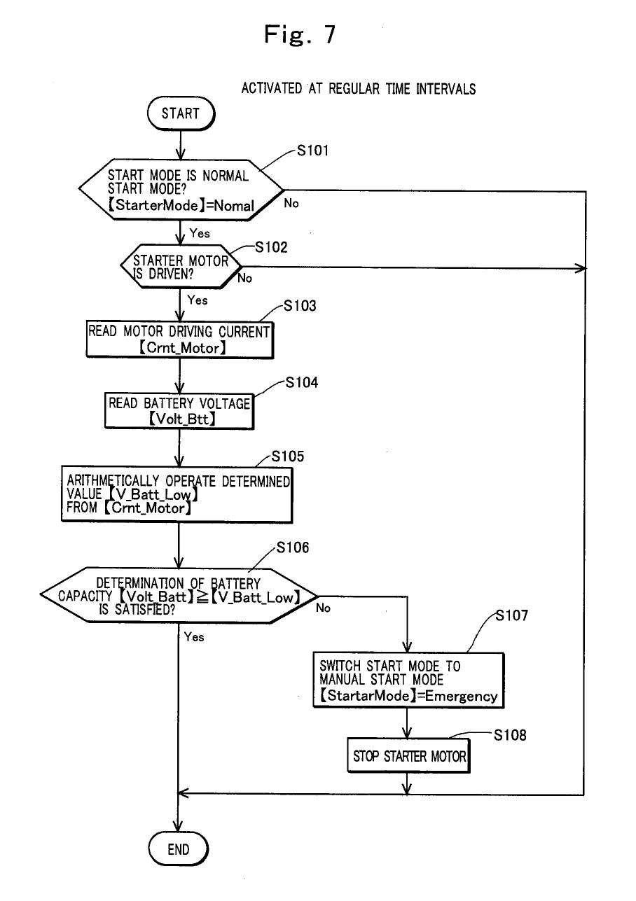

The microprocessor also repeatedly performs the task processing in FIG. 7 at short time intervals, and performs a processing of estimating the remaining capacity of the battery or the like. According to the shown algorithm, first in Step S101, it is determined whether the start mode is the normal start mode. When the start command is given, the start mode is the normal start mode at first. When it is determined in Step S101 that the start mode is not the normal start mode, this processing is finished without performing any processing thereafter. When it is determined in Step S101 that the start mode is the normal start mode, then in Step S102, it is determined whether the starter generator is driven as the starter motor. When it is determined that the starter generator is not driven as the starter motor, this processing is finished without performing any processing thereafter. When it is determined in Step S102 that the starter generator is driven as the starter motor, in Step S103, a driving current (an output current of the battery) Crnt_Motor of the starter generator detected by the current detection portion 33b is read, and in Step S104, a battery voltage Volt_Btt detected by the voltage detection portion 33a is read. Then, in Step S105, a determined value V_Batt_Low is arithmetically operated from the driving current Crnt_Motor of the motor, and in Step S106, the battery voltage Volt_Btt is compared with the determined value V_Batt_Low to estimate the remaining capacity of the battery. In this processing, when the battery voltage Volt_Btt is the determined value V_Batt_Low or more, it is estimated that the remaining capacity of the battery is sufficient for the starter generator to start the engine, and when the battery voltage Volt_Btt is less than the determined value V_Batt_Low, it is estimated that the remaining capacity of the battery is insufficient for the starter generator to start the engine.

In order to allow the determined value V_Batt_Low to be arithmetically operated from the driving current Crnt_Motor, a relationship between the driving current (the output current of the battery) Crnt_Motor, the battery voltage Volt_Btt, and the remaining capacity of the battery required for the starter generator to start the engine is previously calculated by an experiment, and on the basis of the experiment result, a map that provides a relationship between the battery voltage Volt_Btt, the determined value V_Batt_Low to be compared, and the driving current Crnt_Motor is prepared for determining whether the remaining capacity of the battery is sufficient for the starter generator to start the engine when the driving current takes various values. Then, the map is searched with respect to the read driving current Crnt_Motor to perform interpolation calculation and thus arithmetically operate the determined value V_Batt_Low.

When it is estimated in Step S106 that the remaining capacity of the battery is sufficient for the starter generator to start the engine, this processing is finished without performing any processing thereafter, and the normal start mode is kept. When it is estimated in Step S106 that the remaining capacity of the battery is insufficient for the starter generator to start the engine, the process proceeds to Step S107, the start mode is switched to the manual start mode, and in Step S108, the driving of the starter generator as the starter motor is stopped, and this processing is finished.

According to the algorithms in FIGS. 6 and 7, the start mode switching portion 51 is comprised by Step S1 in FIG. 6 and Steps S101, S107 and S108 in FIG. 7. The battery capacity monitoring portion 53 is comprised by Steps S102, S103 to S106 in FIG. 7, and the start time starter driving portion 52 is comprised by Step S2 in the processing in FIG. 6. Further, the normal start time fuel injection control portion 55 is comprised by Step S2 in FIG. 6, and the manual start time fuel injection control portion 57 is comprised by Steps S4, S5, S6, S8, S9, S10 and S11.

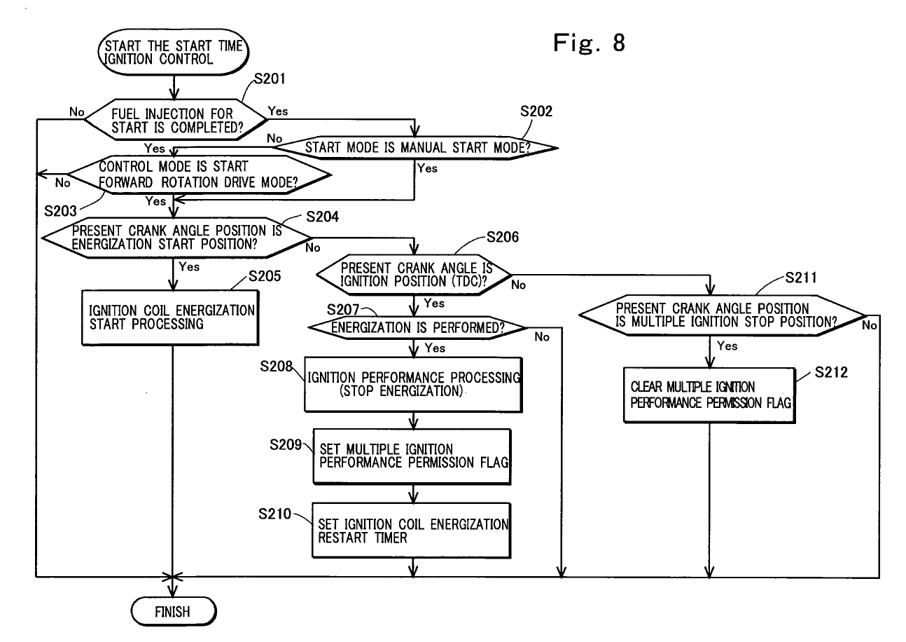

FIGS. 8 to 10 show algorithms of processings performed by the microprocessor for comprising the start time ignition control portion 58. The processing in FIG. 8 is a start time ignition control processing performed when a position for starting energization of the primary current to the ignition coil (an energization start position) is detected and when the ignition position is detected, when the control mode is the start mode. In this example, the ignition position at the start is the top dead center position of the compression stroke, and the energization start position is a position 10° advanced from the top dead center position of the compression stroke.

In the start mode, when it is detected from the output pulses of the Hall sensors that the crank angle position of the engine reaches the top dead center position of the compression stroke of each cylinder, the processing in FIG. 8 is started. When the processing in FIG. 8 is started, in Step S201, it is determined whether the fuel injection for the start performed in Step S11 in FIG. 6 is completed. When it is determined that the fuel injection for the start is not completed, this processing is finished without performing any processing thereafter. When it is determined in Step S201 that the fuel injection for the start is completed, it is determined in Step S202 whether the start mode is the manual start mode. When it is determined that the start mode is not the manual start mode, the process proceeds to Step S203, and it is determined whether the control mode of the starter generator is a start forward rotation drive mode (a mode in which the starter generator is driven in a direction of rotating the crankshaft forward). When it is determined that the control mode is not the start forward rotation drive mode, this processing is finished without performing any processing thereafter. When it is determined in Step S202 that the start mode is the manual start mode, and it is determined in Step S203 that the control mode of the starter generator is the start forward rotation drive mode, the process proceeds to Step S204, and it is determined whether the present crank angle position is the energization start position. When it is determined that the present crank angle position is the energization start position, the process proceeds to Step S205, and a processing for starting energization of the primary current to the ignition coil is started, and then this processing is finished.

When it is determined in Step S204 that the present crank angle position is not the energization start position, the process proceeds to Step S206, and it is determined whether the present crank angle position is the ignition position (the top dead center position of the compression stroke). When it is determined that the present crank angle position is the ignition position, the process proceeds to Step S207, and it is determined whether the energization to the primary coil of the ignition coil is performed. When it is determined that the energization to the primary coil of the ignition coil is not performed, this processing is finished without performing any processing thereafter. When it is determined in Step S207 that the energization to the primary coil of the ignition coil is performed, the process proceeds to Step S208, an ignition performance processing (a processing for stopping the energization of the primary current to the ignition coil) is performed to cause ignition operation in a cylinder with a crank angle position being the top dead center position of the compression stroke. Then, in Step S209, a multiple ignition performance permission flag is set, and in Step S210, an ignition coil energization restart timer is set.

When it is determined in Step S206 in the processing in FIG. 8 that the present crank angle position is not the ignition position, the process proceeds to Step S211, and it is determined whether the present crank angle position is a multiple ignition stop position. When it is determined that the present crank angle position is not the multiple ignition stop position (the present crank angle position is a crank angle position where the multiple ignition is permitted), this processing is finished without performing any processing thereafter. When it is determined in Step S211 that the present crank angle position is the multiple ignition stop position, the process proceeds to Step S212, the multiple ignition performance permission flag is cleared, and then this processing is finished.

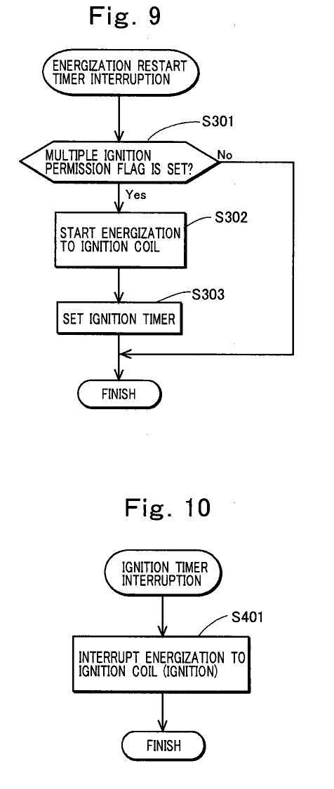

The processing in FIG. 9 is an energization restart timer interruption processing performed every time the energization restart timer measures a predetermined energization restart time for causing multiple ignition while the crank angle position is within a predetermined range after the first ignition is performed at the top dead center position of the compression stroke of each cylinder. When this processing is started, it is determined in Step S301 whether the multiple ignition permission flag is set. When it is determined that the multiple ignition permission flag is not set, this processing is finished without performing any processing thereafter.

When it is determined in Step S301 that the multiple ignition permission flag is set, the process proceeds to Step S302, and energization of the primary current to the ignition coil is started, then in Step S303, a time period between the present time and the time for the next multiple ignition is set in an ignition timer, and the ignition timer is caused to start measurement of the set time period.

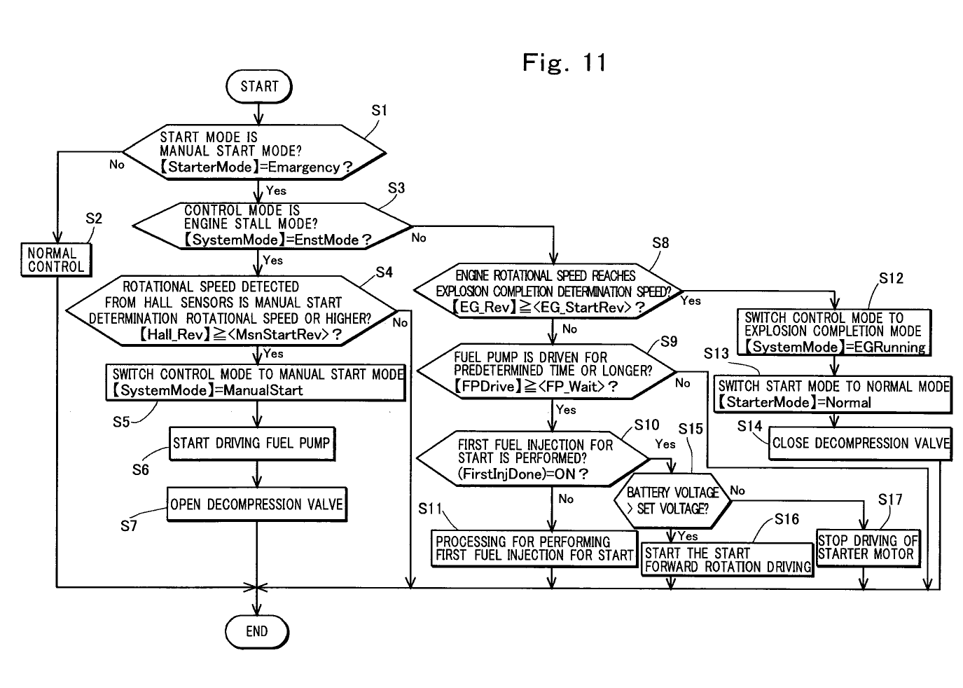

When the ignition timer completes measurement of the set time period (when the multiple ignition position is detected), an ignition timer interruption routine in FIG. 10 is performed. In the interruption routine, Step S401 is performed to perform a processing for interrupting the primary current of the ignition coil to cause the multiple ignition. The multiple ignition is repeatedly performed at time intervals measured by the energization restart timer between when the first ignition is performed at the top dead center position of the compression stroke of each cylinder and when the crank angle position reaches the crank angle position set as the position for stopping the multiple ignition and the multiple ignition permission flag is cleared in Step S212 in the processing in FIG. 8.

The microprocessor 40 confirms from the rotational speed of the engine that the start of the engine is completed, then switches the control mode to the normal operation mode, and performs a processing for comprising a normal operation time fuel injection control portion 71 and a normal operation time ignition control portion 72 that control the ignition position during normal operation.

In the normal operation mode, the processing for comprising the normal operation time fuel injection control portion 71 and the normal operation time ignition control portion 72 is performed. The normal operation time fuel injection control portion 71 arithmetically operates a fuel injection amount required for obtaining a predetermined air/fuel ratio under various control conditions, and provides an injection command having a signal width required for injecting fuel of the arithmetically operated amount at an appropriate injection start position such as a crank angle position immediately before the start of the intake stroke to the injector drive circuit 42.

The normal operation time ignition control portion 72 includes an ignition position arithmetical operation portion that arithmetically operates the ignition position of the engine under various control conditions, and a portion for detecting the arithmetically operated ignition position, and provides an ignition command signal to the ignition circuit to cause the ignition operation when the ignition position arithmetical operation portion detects the arithmetically operated ignition position. The ignition position arithmetical operation portion arithmetically operates a time required for the crankshaft to rotate from a predetermined reference crank angle position to the ignition position at the present rotational speed as ignition position detecting clocking data. When the predetermined reference crank angle position (section number) is detected, measurement of the arithmetically operated ignition position detecting clocking data is started, and when the measurement of the clocking data is completed, the ignition command signal is provided to the ignition circuit 41 to cause the ignition operation. The microprocessor also supplies a driving voltage Visc from the ISC valve drive circuit 43 to an ISC valve 120 so as to maintain a constant idling speed of the engine and controls the ISC valve.

FIG. 11 shows a processing performed at short time intervals in the case where the starter generator is driven as the motor to assist the cranking by the manual starter when the engine is started in the manual start mode, and this processing corresponds to the processing in FIG. 6 in the above described embodiment.

The processing in FIG. 11 is the same as the processing in FIG. 6 other than the addition of Steps S15 and S17 to the processing in FIG. 6. In the processing in FIG. 11, when it is determined in Step S10 that first fuel injection for the start is finished, Step S15 is performed, and it is determined whether a battery voltage is higher than a predetermined set voltage (a minimum voltage required for operating an ignition device and a fuel injection device). When it is determined that the battery voltage is higher than the set voltage, Step S16 is performed to start driving of a starter generator as a starter motor and assist cranking by a manual starter. When it is determined in Step S15 that the battery voltage is not higher than the set voltage, the process proceeds to Step S17, and the driving of the starter generator is stopped. Other points are the same as in the processing in FIG. 6.

According to the algorithm in FIG. 11, a starter assisting portion 60 is comprised by Steps S15 to S17.

In the above described embodiment, the start time starter driving portion 52 is comprised so as to perform the cranking in the cranking pattern of rotating the starter generator forward from the beginning at the start of the engine, but the start time starter driving portion 52 may be comprised so as to perform the cranking in a pattern of once reversely rotating the starter generator to rotate the crankshaft in a direction reverse to the start direction, then reversing the rotational direction of the starter generator, and rotating the crankshaft in the start direction when the start command is given. In this case, the normal start time fuel injection control portion 55 is comprised so as to cause the first fuel injection after the commencement of the starting operation when the cranking performed by reversely rotating the crankshaft is finished, and thereafter cause the fuel injection every time the predetermined fuel injection start position is detected.

Generally, when the engine stops, a piston in a particular cylinder is located near the bottom dead center of the compression stroke. The cranking performed by reversely rotating the crankshaft at the commencement of the starting operation of the engine is preferably performed by reversely rotating the crankshaft of the engine until the piston in the particular cylinder, which has stopped near the bottom dead center of the compression stroke during forward rotation of the engine at the stop of the engine, is located in a section corresponding to an intake stroke during the forward rotation of the engine, or passes through the section corresponding to the intake stroke during the forward rotation.

As described above, the crankshaft is once reversely rotated when the start command is given, and thus an opportunity to inject fuel can be provided in preparation for ignition first performed after the commencement of the starting operation, before the start of the compression stroke first performed in the engine after the starter motor starts the forward rotation. Thus, combustion (initial explosion) can be reliably performed by ignition first performed after the start of the forward rotation of the crankshaft. This allows the initial explosion of the engine to be performed at an early stage to improve startability.

The start time starter driving portion 52 is preferably comprised so as to continuously drive the starter generator as the starter motor in the direction of starting the engine until the start of the engine is confirmed as far as the voltage of the battery is equal to or higher than a voltage value required for operating the ignition device and the fuel injection device, when the crankshaft stops before the piston in the cylinder of the engine reaches the top dead center of the compression stroke.

When output torque of the starter motor is lower than maximum load torque (compression torque) applied to the crankshaft in the compression stroke of the engine, the motor stops if the sum of the compression torque and friction torque exceeds the output torque of the motor in the process of the piston being moved up toward the top dead center in the compression stroke after the commencement of the starting operation. However, generally in a four-cycle engine, a slight compression leak occurs from a piston ring or intake and exhaust valves in the process of the piston being moved up toward the top dead center of the compression stroke, and thus if the starter motor is continuously driven even after the starter motor cannot overcome the compression torque and the friction torque and stops, the piston is slowly moved up with a gradual reduction in the compression torque by the compression leak, and the crankshaft rotates at a low speed. When the piston exceeds a maximum compression torque position (generally, a position around 30° before the top dead center of the compression stroke) before the top dead center of the compression stroke, the load on the starter motor is reduced, thereby causing the crankshaft to start rotating at a higher speed. Thus, the piston easily exceeds the top dead center of the compression stroke, and the compression stroke is completed.

Thus, the starter generator is comprised so as to be continuously driven as the starter motor in the direction of starting the engine until the start of the engine is confirmed when the crankshaft stops before the piston in the cylinder of the engine reaches the top dead center of the compression stroke, thereby improving startability of the engine without increasing cost or the size of the device by using a starter motor having excessive performance. A small-sized starter motor can be used, thereby preventing inertia of the rotor from being excessive to reduce acceleration performance of the engine.

In the embodiments, the starter generator is driven as the starter motor to start the engine, but the present invention may be applied to the case where a rotating electric machine including a magnetic field type rotor mounted to a crankshaft of an engine is used only as a magneto generator, and a starter motor that comprises an electric starter is provided separately from the magneto generator.

In the embodiments, the case of starting the parallel two cylinder four cycle engine is taken as the example, but the present invention may be of course applied to the case of starting a single cylinder four cycle engine or a multicylinder four cycle engine having three or more cylinders.

As described above, according to the present invention, when the driving of the starter motor is started, or when the driving of the starter generator as the starter motor is started, the battery capacity monitoring portion estimates the remaining capacity of the battery. Only when the battery capacity monitoring portion estimates that the remaining capacity of the battery is sufficient, the driving of the starter motor or the starter generator is continued. When the battery capacity monitoring portion estimates that the remaining capacity of the battery is insufficient, the driving of the starter motor or the starter generator is immediately prohibited and the start mode is switched to the manual start mode to cause the manual starter to start the engine. This can prevent the battery from being excessively exhausted, avoid a situation where the engine cannot be completely started, and take the advantage of providing the manual starter together with the electric starter.

In the present invention, the starter assisting portion is provided that monitors the voltage of the battery and drives the starter motor or the starter generator as far as the voltage of the battery is equal to or higher than the voltage value required for operating the ignition device and the fuel injection device to assist the cranking by the manual starter when the manual starter performs the cranking of the engine. Thus, a driving force required for the cranking can be provided also from the starter motor or the starter generator to the crankshaft at the start of the engine in the manual start mode, thereby facilitating the start of the engine, and allowing the start of the engine in the manual start mode even when the displacement of the engine is relatively large. When the starting operation by the manual starter is assisted, the battery voltage is monitored, and the starter motor is driven as far as the battery voltage is equal to or higher than the voltage value required for operating the ignition device and the fuel injection device, thereby preventing the battery from being excessively exhausted.

In the present invention, the manual start mode time fuel injection control portion is provided that starts driving the fuel pump of the fuel injection device immediately after the commencement of the starting operation in the manual start mode, and performs the first fuel injection after the commencement of the starting operation when the driving time of the fuel pump reaches the set time. Thus, the fuel injection can be performed without delay when the starting operation in the manual start mode is commenced, thereby improving startability of the engine.

In the present invention, the engine is ignited at the crank angle position at which the piston of the engine reaches the top dead center of the compression stroke, or the crank angle position delayed from the crank angle position at which the piston reaches the top dead center of the compression stroke at the start of the engine, thereby avoiding a situation where the piston cannot exceed the top dead center and is pushed back at a low cranking speed, and ensuring the start of the engine.

In the present invention, the rotational speed and the crank angle position of the engine required for controlling the ignition device are detected from the outputs of the Hall sensors. Thus, the crank angle position information and the rotational position information of the engine can be precisely obtained even at an extremely low cranking speed, thereby allowing the ignition position at the start to be precisely controlled to improve startability of the engine.

In the present invention, the cylinder of the engine includes the decompression hole that provides communication between each cylinder and the outside, and the decompression valve that can be controlled to open and close the decompression hole, and the decompression valve is controlled so as to be opened when the start mode is switched to the manual start mode, and closed after the initial explosion of the engine is completed, thereby reducing the torque required for the cranking of the engine by the manual starter to facilitate the start of the engine by the manual starter.

In the present invention, in the case where the crankshaft is once reversely rotated when the start command is given, the opportunity to inject fuel can be provided in preparation for ignition first performed after the commencement of the starting operation, before the start of the compression stroke first performed in the engine after a starter forward rotation driving portion starts the forward rotation of the starter motor. Thus, combustion can be reliably performed by the ignition first performed after the forward rotation of the crankshaft, and initial explosion of the engine is performed at an early stage to improve startability.

In the present invention, the start time starter driving portion is comprised so as to continuously drive the starter generator as the starter motor in the direction of starting the engine until the start of the engine is confirmed as far as the voltage of the battery is equal to or higher than the voltage value required for operating the ignition device and the fuel injection device, when the crankshaft stops before the piston in the cylinder of the engine reaches the top dead center of the compression stroke at the start of the engine. Thus, when the maximum load torque applied to the crankshaft of the engine is more excessive than the output torque of the starter motor, and the crankshaft stops or nearly stops before the piston in the cylinder reaches the top dead center of the compression stroke, the gradual reduction in the compression torque by the compression leak of the engine can be used to complete the compression stroke of the engine. Thus, even when the load torque applied to the crankshaft of the engine is more excessive than the output torque of the starter motor, the engine can be started without trouble. This improves startability of the engine without increasing cost or the size of the device by using a starter motor having excessive performance. A small-sized starter motor can be used, thereby preventing inertia of the rotor from being excessive to reduce acceleration performance of the engine.

Although the preferred embodiments of the invention have been described and illustrated with reference to the accompanying drawings, it will be understood by those skilled in the art that there are by way of examples, and that various changes and modifications may be made without departing from the spirit and scope of the invention, which is defined only to the appended claims.

What is claimed is:

1. An engine starting device for starting an engine supplied with fuel by a fuel injection device and ignited by an ignition device, comprising:
a starter motor that drives a crankshaft of said engine at the start of said engine;
a manual starter that is manually driven to perform cranking for starting said engine;
a battery capacity monitoring portion that estimates a remaining capacity of a battery that supplies a driving current to said starter motor;
a start mode switching portion that switches a start mode of said engine between a normal start mode and a manual start mode;
a start time starter driving portion that supplies the driving current from said battery to said starter motor for causing the cranking of said engine when said start mode is the normal start mode; and
a display portion that displays that the cranking for starting said engine is to be performed by said manual starter when said start mode is switched to the manual start mode,
wherein said start mode switching portion is comprised so as to set the start mode to the normal start mode and cause said start time starter driving portion to start supplying the driving current to said starter motor when a start command of said engine is given, then keep the start mode of said engine in the normal start mode when the remaining capacity of the battery estimated by said battery capacity monitoring portion is checked and the remaining capacity of said battery is equal to or larger than a capacity required for said starter motor to start said engine, and prohibit the driving of said starter motor by said starter driving portion and switch the start mode of said engine to the manual start mode when the remaining capacity of said battery estimated by said battery capacity monitoring portion is smaller than the capacity required for starting said engine.

2. The engine starting device according to claim 1, further comprising a starter assisting portion that monitors a voltage of said battery and drives said starter motor as far as the voltage of said battery is equal to or higher than a voltage value required for operating said ignition device and the fuel injection device to assist the cranking by said manual starter when said manual starter performs the cranking of the engine.

3. The engine starting device according to claim 1, further comprising:
a manual start mode time fuel injection control portion that starts driving a fuel pump of said fuel injection device immediately after the commencement of the starting operation in said manual start mode, and causes first fuel injection after the commencement of the starting operation when a driving time of said fuel pump reaches a set time; and
a start time ignition control portion that controls said ignition device so as to ignite said engine at a crank angle position at which a piston of said engine reaches the top dead center of a compression stroke, or a crank angle position delayed from the crank angle position at which said piston reaches the top dead center of the compression stroke, until the start of said engine is completed.

4. The engine starting device according to claim 1, wherein said battery capacity monitoring portion comprises an output current detection portion that detects an output current of said battery, a battery voltage detection portion that detects a voltage of said battery, a remaining capacity estimating determined value arithmetical operation portion that arithmetically operates a determined value to be compared with a detected value of the battery voltage detected by said battery voltage detection portion for estimating the remaining capacity of said battery, with respect to the output current of the battery detected by said output current detection portion, and a battery capacity estimation portion that compares the detected value of the battery voltage detected by said battery voltage detection portion with said determined value, and estimates that the remaining capacity of said battery is equal to or larger than a capacity required for starting said engine when the detected battery voltage is the determined value or more.

5. The engine starting device according to claim 1, wherein said engine comprises, in a cylinder head, a decompression hole that provides communication between each cylinder and the outside, and a decompression valve that can be controlled to open and close said decompression hole, and
said engine starting device further comprises a valve control portion that controls said decompression valve so as to be opened when said start mode is switched to the manual start mode, and closed after initial explosion of said engine is completed.

6. An engine starting device for starting an engine supplied with fuel by a fuel injection device and ignited by an ignition device, comprising:
a starter generator that includes a rotor having a magnetic field and directly connected to a crankshaft of said engine, a stator having a polyphase armature coil, and a Hall sensor that detects a polarity of a magnetic pole of said rotor on the side of said stator to detect a rotational angle position of said rotor, operates as a starter motor when a driving current is supplied to said armature coil according to a detected output of said Hall sensor, and operates as a generator when said rotor is driven by said engine;
a manual starter that is manually driven to perform cranking for starting said engine;
a battery capacity monitoring portion that estimates a remaining capacity of a battery that supplies the driving current to said starter generator;
a start mode switching portion that switches a start mode of said engine between a normal start mode and a manual start mode;
a start time starter driving portion that operates said starter generator as the starter motor and supplies the driving current from said battery to said starter generator according to the output of said Hall sensor for causing the cranking of said engine when said start mode is the normal start mode; and
a display portion that displays that the cranking for starting said engine is to be performed by said manual starter when said start mode is switched to the manual start mode,
wherein said start mode switching portion is comprised so as to set the start mode to the normal start mode and cause said start time starter driving portion to start supplying the driving current to said starter generator when a start command of said engine is given, then keep the start mode of said engine in the normal start mode when the remaining capacity of the battery estimated by said battery capacity monitoring portion is checked and the remaining capacity of said battery is equal to or larger than a capacity required for said starter generator to start said engine, and prohibit the driving of said starter motor by said starter driving portion and switch the start mode of said engine to the manual start mode when the remaining capacity of said battery estimated by said battery capacity monitoring portion is smaller than the capacity required for starting said engine.

7. The engine starting device according to claim 6, further comprising a starter assisting portion that monitors a voltage of said battery and drives said starter generator as the motor as far as the voltage of said battery is equal to or higher than a voltage value required for operating said ignition device and the fuel injection device to assist the cranking by said manual starter when said manual starter performs the cranking of the engine.

8. The engine starting device according to claim 6, further comprising:
a manual start mode time fuel injection control portion that starts driving a fuel pump of said fuel injection device immediately after the commencement of the starting operation in said manual start mode, and causes first fuel injection after the commencement of the starting operation when a driving time of said fuel pump reaches a set time; and
a start time ignition control portion that controls said ignition device so as to ignite said engine at a crank angle position at which a piston of said engine reaches the top dead center of a compression stroke, or a crank angle position delayed from the crank angle position at which said piston reaches the top dead center of the compression stroke, until the starting operation of said engine is completed.

9. The engine starting device according to claim 8, wherein said start time ignition control portion is comprised so as to obtain rotational speed information and crank angle position information of the engine required for controlling said ignition device from the output of said Hall sensor.

10. The engine starting device according to claim 6, wherein said start time starter driving portion is comprised so as to once rotate said crankshaft in a direction reverse to a start direction to cause the cranking of said engine when said start command is given, and then rotate said crankshaft in the start direction to cause the cranking of said engine.

11. The engine starting device according to claim 10, further comprising a normal start time fuel injection control portion that causes first fuel injection after the commencement of the starting operation when the cranking performed by reversely rotating said crankshaft is finished.

12. The engine starting device according to claim 10, wherein said start time starter driving portion is comprised so as to continuously drive said starter generator as the starter motor in the direction of starting the engine until the start of the engine is confirmed as far as the voltage of said battery is equal to or higher than a voltage value required for operating said ignition device and the fuel injection device, when the crankshaft stops before the piston in the cylinder of said engine reaches the top dead center of the compression stroke.

13. The engine starting device according to claim 6, wherein said battery capacity monitoring portion comprises an output current detection portion that detects an output current of said battery, a battery voltage detection portion that detects a voltage of said battery, a remaining capacity estimating determined value arithmetical operation portion that arithmetically operates a determined value to be compared with a detected value of the battery voltage detected by said battery voltage detection portion for estimating the remaining capacity of said battery, with respect to the output current of the battery detected by said output current detection portion, and a battery capacity estimation portion that compares the detected value of the battery voltage detected by said battery voltage detection portion with said determined value, and estimates that the remaining capacity of said battery is equal to or larger than a capacity required for starting said engine when the detected battery voltage is the determined value or more.

14. The engine starting device according to claim 6, wherein said engine comprises, in a cylinder head, a decompression hole that provides communication between each cylinder and the outside, and a decompression valve that can be controlled to open and close said decompression hole, and
said engine starting device further comprises a valve control portion that controls said decompression valve so as to be opened when said start mode is switched to the manual start mode, and closed after initial explosion of said engine is completed.
